(19) United States
(12) Patent Application Publication
(10) Pub. No.: US 2022/0259863 A1
(43) Pub. Date: Aug. 18, 2022

(54) Heated Roofing Underlayment

(71) Applicant: Eric Rinerson, Iron, MN (US)

(72) Inventor: Eric Rinerson, Iron, MN (US)

(21) Appl. No.: 17/671,067

(22) Filed: Feb. 14, 2022

Related U.S. Application Data
(63) Continuation of application No. 63/149,381, filed on Feb. 15, 2021.
(60) Provisional application No. 63/171,693, filed on Apr. 7, 2021.
(60) Provisional application No. 63/196,419, filed on Jun. 3, 2021.
(60) Provisional application No. 63/214,905, filed on Jun. 25, 2021.
(60) Provisional application No. 63/257,947, filed on Oct. 20, 2021.

(51) Int. Cl. E04D 13/10; H05B 1/02; H05B 3/20; F24D 3/12; E04D 12/00

(52) U.S. Cl. CPC E04D 13/103; H05B 1/0205; H05B 3/20; H05B 2214/02; E04D 12/002; H05B 2203/011; F24D 3/12

(57) ABSTRACT

This application discloses a heated roofing underlayment placed between roof sheathing and the roofing surface. Building structures in climates that experience freezing temperatures and snowfall may develop problems associated with freezing moisture on the surface of a roof. This freezing moisture may lead to problems that result in moisture penetration into the structure, structural damage, rot, and other damage. The heated roofing underlayment may cause the ice and snow on a roof to melt.

### CROSS-REFERENCE TO RELATED APPLICATION(S)

This application claims the priority and benefit to U.S. Provisional Patent Application No. 63/149,381 filed Feb. 15, 2021, 63/171,693 filed Apr. 14, 2021, 63/196,419 filed Jun. 10, 2021, 63/214,905 filed Jul. 22, 2021, and 63/257,947 filed Oct. 29, 2021. the contents of which are hereby incorporated by reference in its entirety.

### BACKGROUND

Building structures in climates that experience freezing temperatures and snowfall may develop problems associated with freezing moisture on the surface of a roof. This freezing moisture may lead to problems that result in moisture penetration into the structure, structural damage, rot, and other damage. Typically, the frozen moisture accumulates near the edge of the roof and can form ice dams.

Roofing is often installed with underlayment placed immediately adjacent to the roofs edge. Such underlayment material is placed beneath the top layer or layers of material covering the roof.

### SUMMARY

The present application discloses a heated roofing underlayment placed between roof sheathing and the roofing surface.

An exemplary heated roofing underlayment includes a layer of material that is attached to a heating element. The layer of material is typically consistent with widely available roofing underlayment as used on roofs to protect the roof from moisture or wind penetration. The heating element can employ a variety of energy sources and heating mediums.

### BRIEF DESCRIPTION OF THE DRAWINGS

These and other features and advantages of the present invention will become more readily appreciated as the same becomes better understood by reference to the following detailed description when considered in connection with accompanying drawings, wherein:

FIG. 1 shows a perspective view of a building that has roof planes;

FIG. 2 shows an underlayment with a sinusoidal wave embodiment;

FIG. 3 shows an underlayment showing an embodiment with a mainline and smaller heat element loops;

FIG. 4 shows a cross section of one embodiment of roofing layers;

FIG. 5 shows an underlayment with perpendicularly placed heating element;

FIG. 6 shows an underlayment with multiple perpendicularly placed heating elements;

FIG. 7 shows an underlayment with multiple perpendicularly placed heating elements and diagonally placed heating elements;

FIG. 8 shows an underlayment with multiple perpendicularly placed heating elements where the heating elements are stacked transversely;

FIG. 9 displays an underlayment showing an embodiment with a mainline located near the center of the underlayment and smaller heat element loops; and

FIG. 10 shows a control box that can control electric energy delivered to distinct mainlines.

### DETAILED DESCRIPTION OF THE ILLUSTRATED EMBODIMENTS

### General

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

### Figures Detail

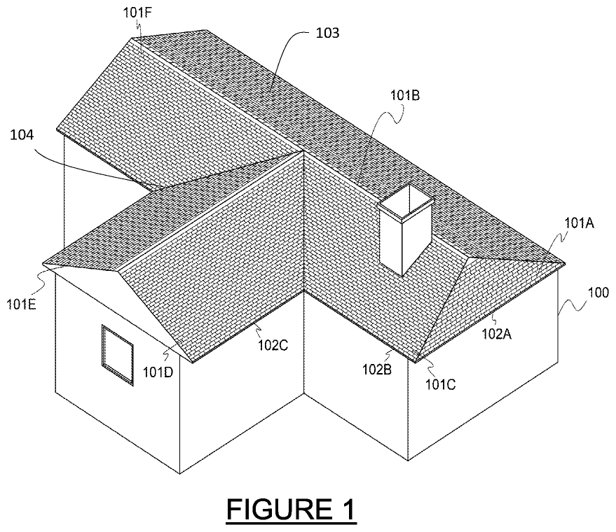

In FIG. 1, a building structure 100 is shown with a plurality of roof planes 101A-101F. The term “roof plane” as used herein is defined as a plane or flat portion of the roof formed by an area of roof deck. The building structure 100 has a variety of eaves 102A-102F. The term “edges” or “edge” is defined as where a roof plane ends. The term “valley” is defined as the internal angle formed by the intersection of two sloping roof planes. While the building illustrated in FIG. 1 is a residential home, it will be understood that the building structure 100 may be any type of structure, such as, for example, a garage, church, office, arena, commercial building, or any other type of building.

The roof 103 of the building structure 100 may include any combination of planes, edges, and valleys.

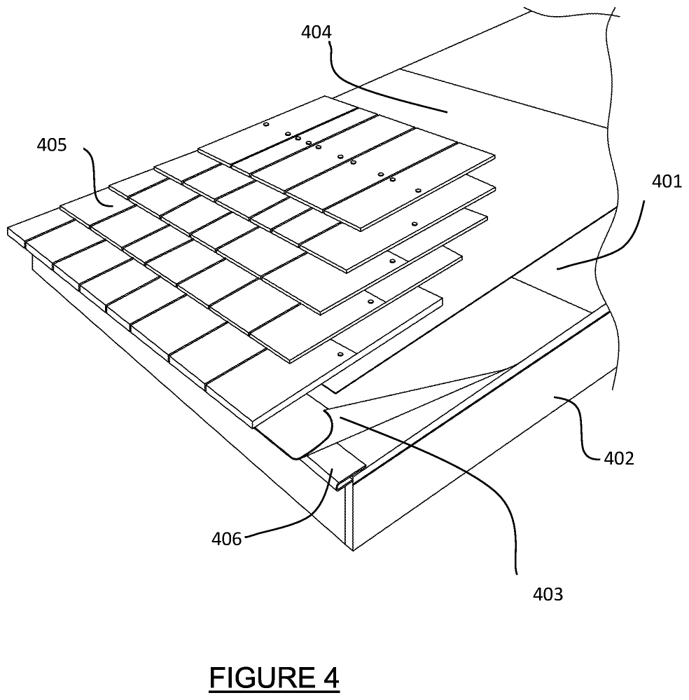

FIG. 4 illustrates one type of roof system of a building. This exemplary roof system is comprised of a sheathing 401, a structure 402, an ice and water protector 403, a felt layer 404, a roof covering 405, and a drip edge 406. The sheathing 401 is placed on top of a structure 402, which holds the sheathing in place. The sheathing is often OSB or plywood nailed or screwed to the structure 402. The sheathing is often covered at and near the edges by an ice and water protector 403. Other water resistant or waterproof materials are also often placed between the sheathing and the roof covering. Other such material is defined as “felt” and includes but is not limited to asphalt-saturated felt, non-bitumen synthetic, and rubberized asphalt. Roof systems can be comprised of many variations of materials and layers. Many roofs found on residential buildings have an ice and water protector installed on the sheathing as noted herein, followed by a layer of felt, and finally a roof covering. Ice and water protector and felt are not always installed, and any combination of material may be used on a roof. While the roof in FIG. 4 displays one combination of planes, edges, and valleys, there may be many other combinations, for example, a steeper slope, a shallower slope, flat roofs, slopes extending to various sides of the build, and any other variation.

Different combinations of roofing material are typically placed over the sheathing and ice and water protector. The layer or layers immediately exposed to the exterior of the roof system are considered the roof covering. Examples of roof covering include but are not limited to shingles, steel panels, plastic polymers, slate, shake, concrete, tile, and others commonly understood in the industry.

It is common within the art for roof valleys to be installed with an ice and water protector over the top of the sheathing.

The term “ice and water protector” is sometimes referred to as an “ice water shield,” an “ice and water barrier,” an “ice and snow protectors,” and other similar terms by those with ordinary skill in the art. Ice and water protectors often comprise a peel and stick surface that adheres to the sheathing and a waterproof layer. The ice and water protector is often flexible such that it typically comes in a roll. Rolls of ice and water protector often are produced in 3 foot widths and various lengths. Width may be of any variety depending on the application. Often, an ice and water protector has a thickness of 55-65 mil but may come in various thicknesses. The peel and stick surface is not always used for attaching the ice and water protector to the sheathing and, in some embodiments, may not be included. Ice and water protector may also come in the form of a rigid material.

The term “underlayment” used herein is defined as any materials defined as an ice and water protector, felt, or other variation. Such underlayment may come in the form of a flexible roll or a rigid piece.

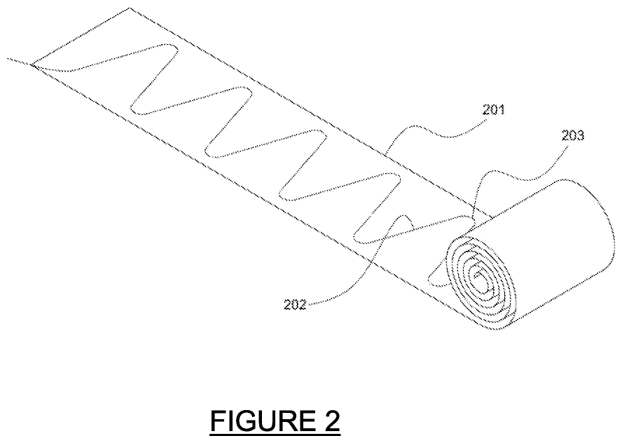

FIG. 2 shows an embodiment of the invention in which a heating element is attached to an underlayment 201 in such a way that the heating element 202 is laid out linearly in a sine wave formation 203. In this embodiment, the heating element is embedded in the ice and water protector during the manufacturing process for the underlayment. The heating element may be attached to the ice and water protector in any variation of wavelength, wave height, or loop. The term sine wave or sinusoidal wave does not mean the heating element is laid out in a manner that is mathematically consistent with a sine wave calculation, rather it is a descriptor of a continuous heating element. One or more inline fuses may be placed to protect from short circuiting. For the embodiment described in FIG. 2, sinusoidal waves may be approximately 4 feet in length, but the installation of such heating elements may vary in length, shape, and pattern.

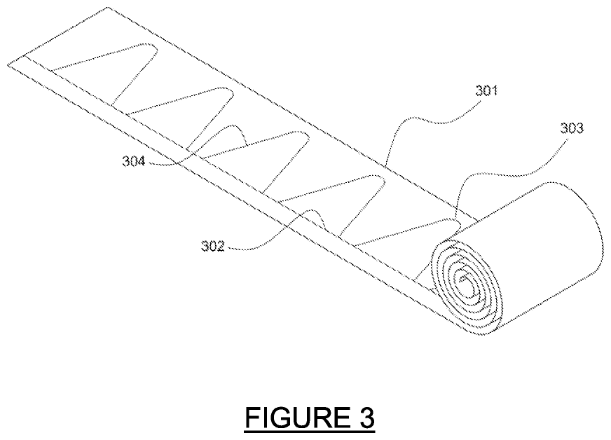

FIG. 3 is an illustration showing an embodiment of the invention in which the branch line heating elements 303 are attached to an underlayment 301 in such a way that there is a mainline 302 for transmitting heating energy to branch line heating elements 303 embedded in the underlayment 301. The mainline 302 may comprise a non-heat emitting line for transmitting heating energy to the branch line heating elements 303 or as a heat emitting element that both transmits energy to the branch line heating elements 303 acting as a heating element. Multiple mainlines 302 may be connected to the ice and water protector to create a system using multiple circuits. For electrical heating elements, a fuse 304 may be placed in smaller branch lines to provide redundancy if one of the branch line heating elements fails. The mainline 302 and the branch line heating elements 303 are electrically connected when the heating elements are distributing heat derived from electricity. In FIG. 3 the mainline 302 is approximately 1″ from the edge of the ice and water protector, though it may be installed in any relation to the edge of the ice and water protector.

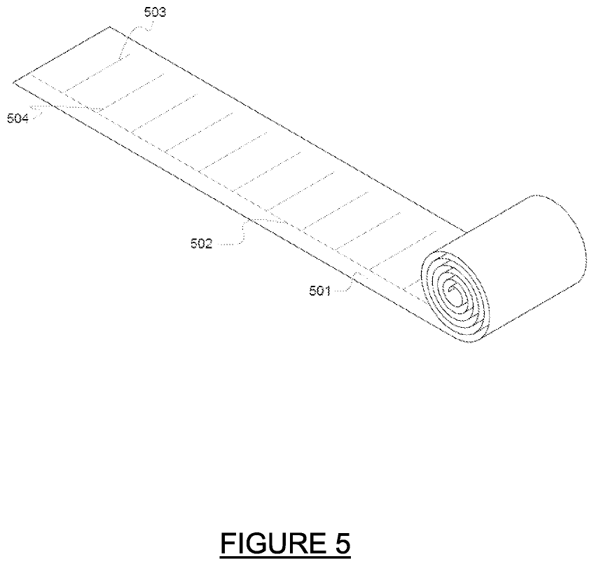

FIG. 5 shows an embodiment of the invention in which branch line heating elements 503 are attached perpendicularly to a mainline 502 which are embedded in an underlayment 501. In this embodiment, the branch line heating elements 503 are placed in a line. In addition, a fuse 504 may be placed in any of the branch line heating elements to protect from overcurrent.

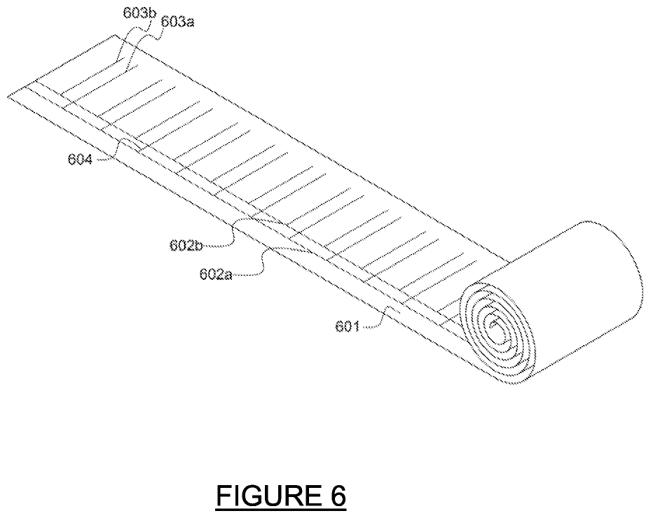

FIG. 6 is an illustration showing an embodiment of the invention in which two sets of branch line heating elements 603 a-b are attached perpendicularly to two sets of mainlines 602a-b which are embedded in an underlayment 601. There is a first mainline 602a and a second mainline 602b. In this embodiment, the branch line heating elements 603a-b are placed in a line. In addition, a fuse 604 may be placed in any of the branch line heating elements to protect from overcurrent.

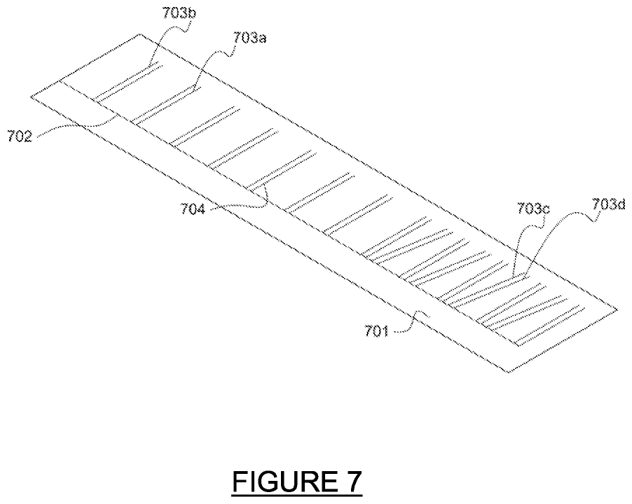

FIG. 7 shows an embodiment of the invention in which two sets of branch line heating elements 703a-d are attached both perpendicularly and diagonally to a mainlines 702 which is embedded in an underlayment 701. In this embodiment, the branch line heating elements 703 a-b are placed perpendicularly to the mainline 702. In this illustration, the diagonally connected branch line heating elements 703c-d are located in the last 15 feet of the underlayment 701. Placing branch line heating elements at a diagonal in the last 15 feet may be useful for emitting more heat at a location closer to a hip or a valley 104. In addition, a fuse may be placed in any of the branch line heating elements to protect from overcurrent.

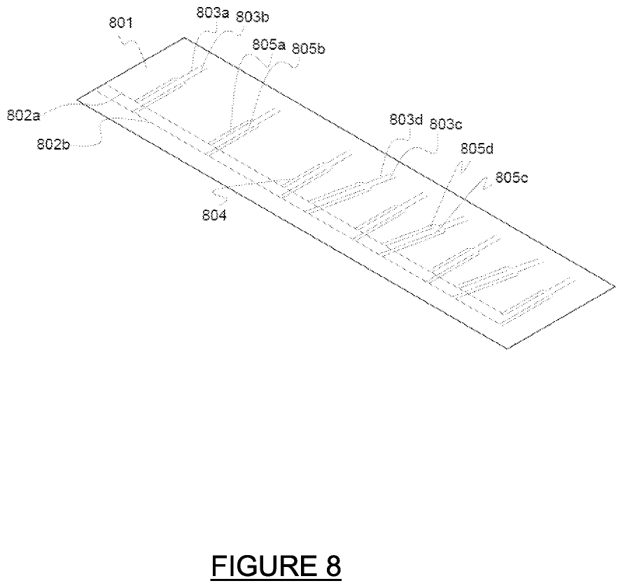

FIG. 8 shows an embodiment of the invention in which four sets of branch line heating elements 803a-d and 805a-d are attached both perpendicularly and diagonally to two sets of mainlines 802a-b which are embedded in an underlayment 801. In this embodiment, the branch line heating elements 803a-d and 805a-d are placed in a line. In this illustration, the diagonally connected branch line heating elements 803c-d and 805c-d are located in the last 15 feet of the underlayment 801. Placing branch line heating elements at a diagonal in the last 15 feet may be useful for emitting more heat at a location closer to a hip or a valley 104. In addition, a fuse 804 may be placed in any of the branch line heating elements to protect from overcurrent.

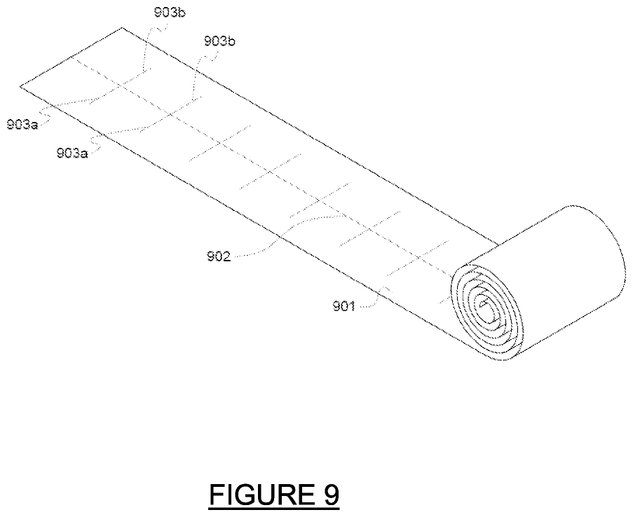

FIG. 9 shows an embodiment of the invention in which a mainline 902 is located near the center of an underlayment 901. Branch line heating elements 903a-b are located perpendicularly on either side of the mainline 902. The application for this embodiment may include use in a valley 104 or other areas of the roof where it is beneficial to locate the mainline 902 near the center of the underlayment 901.

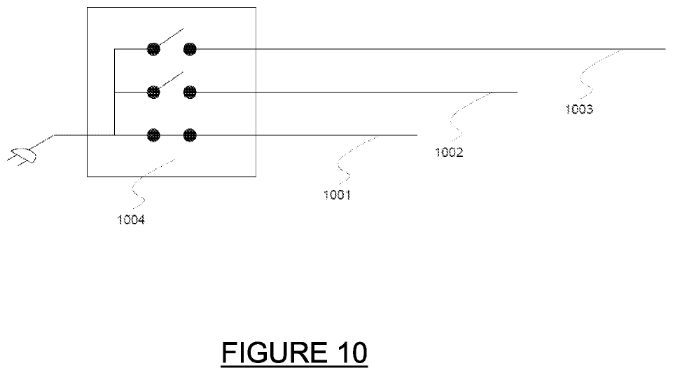

FIG. 10 is an illustration showing one possible embodiment of a control box 1004 that regulates how electric energy is delivered to electrically separated mainlines. In this example, the control box 1004 is designed using methods common to those in the art such that three electrically separated mainlines may be delivered electrical energy from the same energy source. Switches, transistors, or other standard electrical devices may be used to turn on the first mainline 1001 separately from the second mainline 1002 and the third mainline 1003. A control box is not limited to any minimum or maximum number of mainlines or minimum or maximum number of mainlines which may be delivered electric energy at any particular time.

Branch line heating elements need not be located at any specific angle in relation to the mainline. Branch line heating elements that are described as being perpendicular to a mainline may include branch line heating elements being located at angles anywhere from 45 degrees to 135 degrees.

One alternative embodiment of the invention may be perpendicularly placing branch line heating elements in relation to a mainline. Further, each respective branch line heating element under such arrangement can be placed into one combined heating element package rather than a circuit using multiple lines. Effectively, this variation allows for a branch line heating element to be connected to the mainline at near the same location. Alternatively, heating elements can be placed on diagonals or other desired angles.

Embedding or placing the heating element within the underlayment or upon the underlayment may be accomplished using many commonly known manufacturing techniques available to those with ordinary skill in the art.

Both ends of the ice and water protector may have a heating element connection exposed for electrical applications. The exposed electrical connection will preferably extend 2 inches out of the ice and water protector. A water-tight female connector may be attached to the exposed electrical connection such that multiple sections of ice and water protectors can be joined. A male union can be used to join the multiple sections.

In some embodiments, markings may be placed on the surface of an underlayment that is attached to a heating element in such a way that the location of the heating element is communicated. An example of such labeling may include a white line that is placed directly over the heating element at all locations on the underlayment.

In some embodiments, the heating element may rest in a hollow tube such that the heating element may be replaced in the event of the heating element failing.

Energy sources may include electric or heating fluid heated by a boiler or other heating method. An example of an electric heating source includes a standard residential wall outlet. A DC battery source could also be used as an energy source.

The preferred embodiment for the heating element is an electric heat tape or wire that employs the use of a simple two-wire connection. The preferred embodiment would be a self-regulating heat tape using approximately six watts per foot and could be plugged into any twenty-amp AC circuit. Other heating elements may include a liquid-based heating element that continuously circulates heated liquid through the heating elements heated by an external-based liquid warming apparatus. Resistance-based heating elements, like Nifethal 52, are also heating elements that can be employed.

Connections between underlayment segments may be made using any commonly used commercially available connector for the respective heating element embodiment. A simple two-wire connection is employed for the preferred embodiment using an electrical heat tape or wire. Heat tape or wire which can be cut, spliced, and joined at any point will be used in the embodiment such that the underlayment may cut or modified at any point to conform to the roof plane. Some embodiments allow for the heating element to be periodically exposed to the surface of the underlayment such that access for cutting, splicing, or joining may be available. The mainline may be connected to a connector for joining the roof warming material with a second roof warming material or an energy source.

Ice and water protector sections may be joined by connecting the heating elements. When the heating element is electrical, splicing kits can be used to join heating elements that are cut in the middle of an ice and water protector section. Splicing kits can connect two sections together or can be implemented as a splitter kit such that more than two sections are joined together. Joining multiple sections together may be important when multiple planes of a roof, such as a valley, converge.

A simple termination may be made at the end of the heating element. For example, such termination may be an electrical cover for electrical heating elements or for a fluid-based heating element a simple cap may be installed.

When the heating element is electrical, a fuse may be placed in the circuit to reduce the risk of overcurrent.

### Explanation of Exemplary Language

While various inventive aspects, concepts and features of the general inventive concepts are described and illustrated herein in the context of various exemplary embodiments, these various aspects, concepts and features may be used in many alternative embodiments, either individually or in various combinations and sub-combinations thereof.

Unless expressly excluded herein all such combinations and sub-combinations are intended to be within the scope of the general inventive concepts. Still further, while various alternative embodiments as to the various aspects, concepts and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A roof warming material comprising:
an underlayment, the underlayment covers an edge on a roof; the roof having a sheathing that is covered by the underlayment, the underlayment covered by a roof covering;
a mainline, the mainline attached to the underlayment; and
a heating element, the heating element for distribution of heating energy.

2. The roof warming material of claim 1, further comprising a branch line, the branch line connected to the mainline, wherein the mainline transmits heating energy to the branch line.

3. The roof warming material of claim 2, wherein a fuse is placed between the mainline and the branch line.

4. The roof warming material of claim 2, wherein the mainline is a non-heat emitting line.

5. The roof warming material of claim 2, wherein the mainline is a heat emitting line.

6. The roof warming material of claim 2, wherein the branch line is connected to the mainline on each end of the branch line.

7. The roof warming material of claim 2, wherein the branch line is connected perpendicularly to the mainline.

8. The roof warming material of claim 1, further comprising a second mainline.

9. The roof warming material of claim 1, wherein the heating element uses electricity to transmit heating energy.

10. The roof warming material of claim 1, wherein the heating element uses a heated water source to transmit heating energy.

11. The roof warming material of claim 2, wherein the underlayment is labeled on its surface to show where the branch line is located.

12. The roof warming material of claim 1 wherein the mainline is connected to a connector for joining the roof warming material with a second roof warming material or an energy source.

13. The roof warming material of claim 1, wherein the underlayment and the mainline are flexible and can be rolled onto the sheathing.

14. The roof warming material of claim 1, wherein the underlayment is rigid.

15. A roof warming material comprising:
an underlayment, the underlayment covers an edge on a roof; the roof having a sheathing that is covered by the underlayment, the underlayment covered by a roof covering;
a mainline, the mainline attached to the underlayment, the mainline is connected to a connector for joining the roof warming material with a second roof warming material or an energy source, the underlayment and the mainline are flexible and can be rolled onto the sheathing;
a heating element, the heating element for distribution of heating energy, the heating element uses electricity to transmit heating energy;
a branch line, the branch line connected to the mainline, wherein the mainline transmits heating energy to the branch line, the underlayment is labeled on its surface to show where the branch line is located; and
a fuse, the fuse is placed between the mainline and the branch line.
